(19) United States
(12) Patent Application Publication
(10) Pub. No.: US 2013/0327466 A1
(43) Pub. Date: Dec. 12, 2013

(54) INSULATED TUBING

(71) Applicant: Pellegrino J. Pisacreta, Newtown, CT (US)

(72) Inventor: Pellegrino J. Pisacreta, Newtown, CT (US)

(21) Appl. No.: 13/492,321

(22) Filed: Jun. 8, 2012

(51) Int. Cl. B32B 1/08; B32B 37/06; F16L 9/14; B32B 1/06

(52) U.S. Cl. 156/86; 428/34.9; 428/34.6; 138/140

(57) ABSTRACT

A tubing includes an inner tube, an inner middle insulation layer, an outer middle securing layer, and an outer shrinkable cover that shrinks upon exposure to heat.

### BACKGROUND OF THE INVENTION

Tubing is employed to transport fluid through a gas turbine engine. Insulated tubing can include an inner metal tube with a surrounding insulation layer. In one example, the insulation layer is made of a solid material. A metal cover surrounds the insulation layer and retains the insulation layer on the inner metal tube.

The metal cover is formed from two flat pieces of metal. The pieces of metal are stamped to form a shell portion having a partial tubing shape. The metal inner tube and the insulation layer are located between two shell portions that are secured together by welding or brazing to form the metal cover. The metal cover is expensive, requires expensive tooling, and can take a long time to create.

### SUMMARY OF THE INVENTION

A tubing includes an inner tube, an inner middle insulation layer, an outer middle securing layer, and an outer shrinkable cover that shrinks upon exposure to heat.

In a further non-limiting embodiment of the foregoing tubing, an inner tube is made of one of a nickel alloy, a titanium alloy, a nickel-chromium alloy, and stainless steel.

In a further non-limiting embodiment of the foregoing tubing, an inner tube has an outer diameter of about 0.375 inch to about 0.5 inch.

In a further non-limiting embodiment of the foregoing tubing, an inner middle insulation layer includes two outer layers and an insulation filler located therebetween.

In a further non-limiting embodiment of the foregoing tubing, two outer layers include ceramic fibers and the insulation filler has a chalky consistency.

In a further non-limiting embodiment of the foregoing tubing, an insulation filler is contained in chambers defined between the two outer layers, and the chambers are defined by stitching.

In a further non-limiting embodiment of the foregoing tubing, an inner middle insulation layer has a thickness of about 0.14 inch.

In a further non-limiting embodiment of the foregoing tubing, an outer middle securing layer is a ceramic tape layer.

In a further non-limiting embodiment of the foregoing tubing, an outer middle securing layer has a thickness of about 0.32 inch.

In a further non-limiting embodiment of the foregoing tubing, an outer shrinkable cover is polytetrafluoroethylene.

In a further non-limiting embodiment of the foregoing tubing, an outer shrinkable cover has an outer diameter of about 0.68 inch to about 0.775 inch.

A tubing includes an inner tube of metal, an inner middle insulation layer, an outer middle securing layer formed of a ceramic tape layer, and an outer shrinkable cover of polytetrafluoroethylene that shrinks upon exposure to heat.

In a further non-limiting embodiment of the foregoing tubing, the inner tube is made of one of a nickel alloy, a titanium alloy, a nickel-chromium alloy, and stainless steel.

In a further non-limiting embodiment of the foregoing tubing, the inner middle insulation layer includes two outer layers and an insulation filler located therebetween, and the two outer layers include ceramic fibers and the insulation filler has a chalky consistency.

In a method of making a tubing, the method includes the steps of positioning an inner middle insulation layer around an inner tube and positioning an outer middle securing layer over the inner middle insulation layer to retain the inner middle insulation layer. The method also includes the steps of pulling an outer shrinkable cover over the outer middle securing layer and then heating areas of the outer shrinkable cover to shrink the outer shrinkable cover.

In a further non-limiting embodiment of the foregoing method, the inner tube is made of one of a nickel alloy, a titanium alloy, a nickel-chromium alloy, and stainless steel.

In a further non-limiting embodiment of the foregoing method, the step of positioning the inner middle insulation layer around the inner tube includes wrapping the inner middle insulation layer around the inner tube such that edges of the inner middle insulation layer contact or overlap, where the inner middle insulation layer includes two outer layers and an insulation filler located therebetween, and the two outer layers includes ceramic fibers and the insulation filler has a chalky consistency.

In a further non-limiting embodiment of the foregoing method, the step of positioning the outer middle securing layer over the inner middle insulation layer includes wrapping the outer middle securing layer around the inner middle insulation layer, and the outer middle securing layer is formed of ceramic tape.

In a further non-limiting embodiment of the foregoing method, the outer shrinkable cover includes small diameter portions and large diameter portions, and the small diameter portions are located over straight portions of the tubing and the large diameter portions are located over curved portions of the tubing, where the outer shrinkable cover is polytetrafluoroethylene.

In a further non-limiting embodiment of the foregoing method, the step of then heating the areas of the outer shrinkable cover includes applying heat at a temperature of about 750° F. for about one minute to about one and a half minutes at the areas of the tubing.

In a further non-limiting embodiment of the foregoing method, the areas of the outer shrinkable cover are about one square inch.

These and other features of the present invention can be best understood from the following specification and drawings, the following of which is a brief description.

### BRIEF DESCRIPTION OF THE DRAWINGS

FIG. 1 illustrates a simplified cross-sectional view of a standard gas turbine engine;

FIG. 2 illustrates a cross-sectional view of a tubing;

FIG. 3 illustrates a perspective view of an insulation layer of the tubing prior to placement on an inner tube of the tubing;

FIG. 4 illustrates a cross-sectional view of the insulation layer;

FIG. 5 illustrates the tubing once a shrinkable cover is pulled over a ceramic tape layer;

FIG. 6 illustrates a flowchart of a method of making the tubing; and

FIG. 7 illustrates the tubing with attached clamps.

### DETAILED DESCRIPTION OF THE PREFERRED EMBODIMENTS

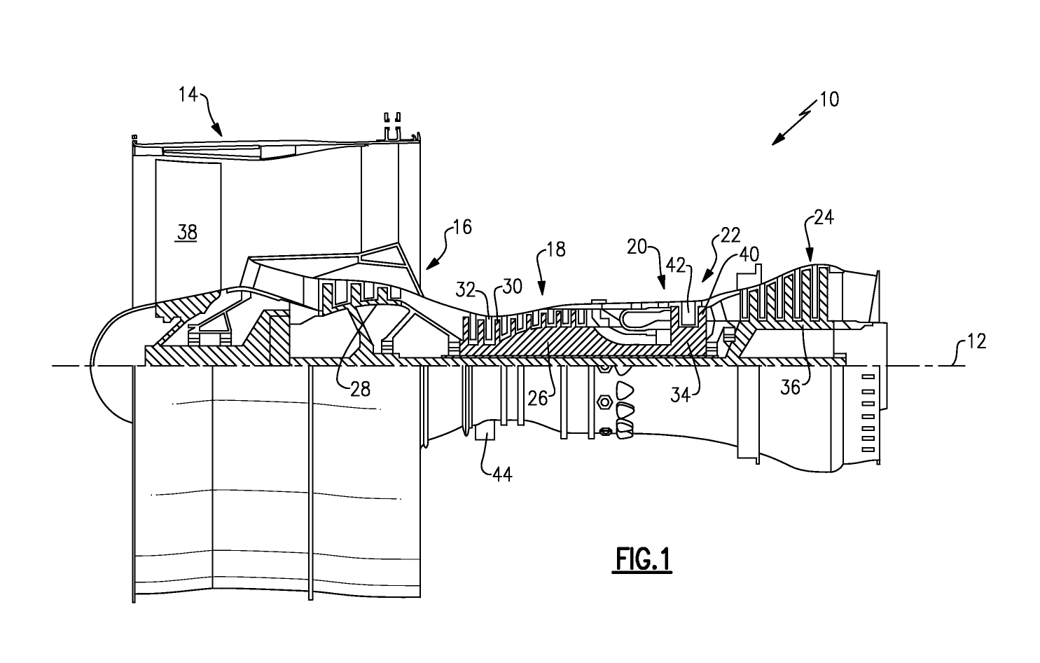

FIG. 1 illustrates a gas turbine engine 10 that is circumferentially disposed about an axis 12. The gas turbine engine 10 includes a fan section 14, a low-pressure compressor section 16, a high-pressure compressor section 18, a combustion section 20, a high-pressure turbine section 22, and a low-pressure turbine section 24.

During operation, air is compressed in the low-pressure compressor section 16 and the high-pressure compressor section 18. The compressed air is then mixed with fuel and burned in the combustion section 20. The products of combustion are expanded across the high-pressure turbine section 22 and the low-pressure turbine section 24.

The high-pressure compressor section 18 and the low-pressure compressor section 16 include rotors 26 and 28, respectively. The rotors 26 and 28 are configured to rotate about the axis 12, driving the compressors 16 and 18. The compressors 16 and 18 include alternating rows of rotating compressor blades 30 and static airfoils or vanes 32.

The high-pressure turbine section 22 includes a rotor 34 that is rotatably coupled to the rotor 26, and the low-pressure turbine section 24 includes a rotor 36 that is rotatably coupled to the rotor 28. The rotors 34 and 36 are configured to rotate about the axis 12 in response to expansion. When rotated, the rotors 34 and 36 drive the high-pressure compressor section 18 and the low-pressure compressor section 16. The rotor 36 also rotatably drives a fan 38 of the fan section 14. The turbines 22 and 24 include alternating rows of rotating airfoils or turbine blades 40 and static airfoils or vanes 42.

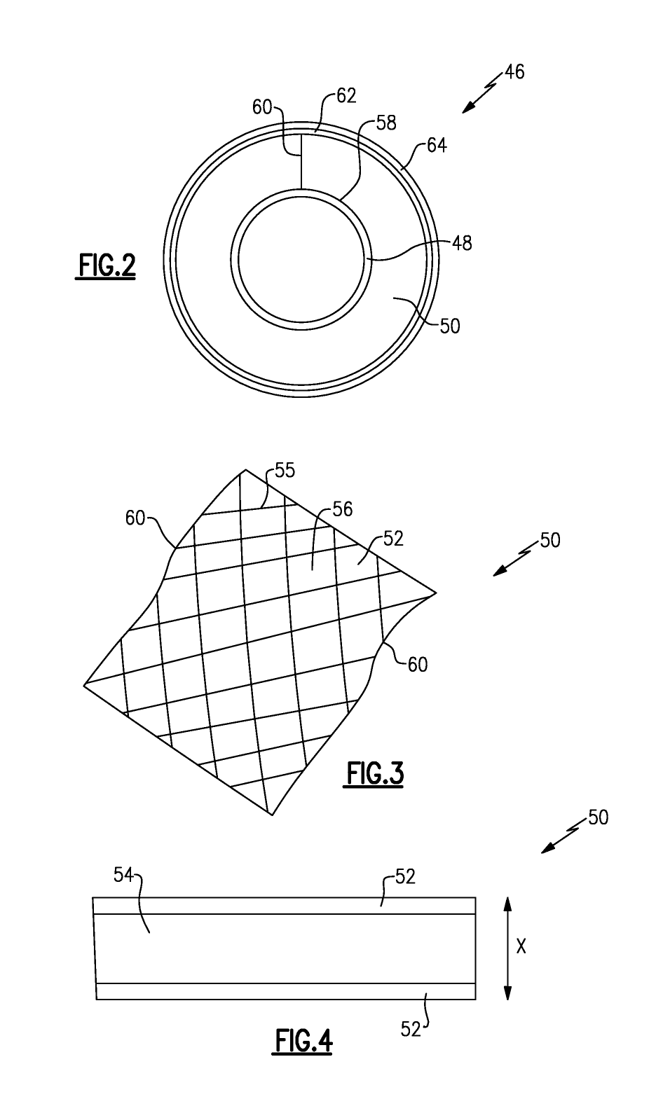

The gas turbine engine 10 also includes at least one fluid system 44 including tubing 46 (shown in FIG. 2) through which fluid flows. The fluid system 44 can be an oil system, a fuel distribution system, a coolant system, or any type of system that transports fluid though the gas turbine engine 10. Any fluid can flow through the tubing 46. In one example, the fluid is water, air, coolant or oil.

FIG. 2 illustrates a cross-sectional view of the tubing 46. The tubing 46 includes an inner tube 48. In one example, the inner tube 48 is made of metal. In one example, the inner tube 48 is made of a nickel alloy, a titanium alloy, a nickel-chromium alloy, or stainless steel. In one example, the inner tube 48 has an outer diameter of about 0.375 inch (0.95 cm) to about 0.5 inch (1.27 cm).

The tubing 46 includes an insulation layer 50 that is located outside the inner tube 48. In one example, the insulation layer 50 provides thermal insulation. As shown in FIGS. 3 and 4, the insulation layer 50 is provided as a pre-formed sheet or blanket. In one example, the insulation layer 50 has a thickness X of about 0.14 inch (0.36 cm). In one example, the insulation layer 50 includes two outer layers 52 and an insulation filler 54 located between the two outer layers 52. In one example, stitching 55 contains and seals the insulation filler 52 in chambers or compartments 56 defined between the two outer layers 52. In one example, the chambers or compartments 56 are diamond shaped.

In one example, the insulation filler 54 has a chalky consistency and is flexible. In one example, the insulation filler 54 is MIN-K®, sold by Johns-Manville Corporation of New York, N.Y. In one example, the two outer layers 52 are formed of a heavy thermal fabric including ceramic fibers. In one example, the two outer layers 52 are Nextel woven fabric 312, sold by 3M of St. Paul, Minn.

The insulation layer 50 is custom cut to size to fit around an outer surface 58 of the inner tube 48. The insulation layer 50 is then wrapped around the outer surface 58 of the inner tube 48 such that edges 60 of the insulation layer 50 contact or overlap.

Once the insulation layer 50 is wrapped around the inner tube 48, tape is wrapped around the insulation layer 50 to form a tape layer 62 that secures the contacting or overlapping edges 60 of the insulation layer 50 together and retains the insulation layer 50 in place. In one example, the tape layer 62 has a thickness of about 0.32 inch (0.81 cm). In one example, the tape layer 62 is a ceramic tape layer.

A shrinkable cover 64 is then pulled over the tape layer 62. Once shrunk, the shrinkable cover 64 provides a seal over the insulation layer 50. In one example, the shrinkable cover 64 is made of a shrinkable fluorocarbon that shrinks at a certain temperature. In one example, the shrinkable cover 64 is made of polytetrafluoroethylene (PTFE). The shrinkable cover 64 is pulled over the tape layer 62 in sections 64a and 64b.

As shown in FIG. 5, the sections 64a and 64b of the shrinkable cover 64 have different diameters. In one example, the sections 64a of the shrinkable cover 64 having a smaller diameter are located over straight portions of the tubing 46. The sections 64b of shrinkable cover 64 having a larger diameter are located over curved portions of the tubing 46 (shown in FIG. 5 not to scale, but for illustrative purposes only) to accommodate for the larger diameter created by the curves and bends of the tubing 48. In one example, the sections 64a of the shrinkable cover 64 having the smaller diameter have an outer diameter of about 0.68 inch (1.73 cm), and the sections 64b of the shrinkable cover 64 having the larger diameter have an outer diameter of about 0.775 inch (1.97 cm).

The shrinkable cover 64 is then heated, causing the shrinkable cover 64 to shrink and reduce in size, creating a seal over the insulation layer 50. A heating element 66, for example a heat gun, applies heat to an area of the shrinkable layer 64 to shrink the area of the shrinkable cover 64 that is exposed to the heat. In one example, the heating element 66 applies heat at a temperature of about 750° F. (398.9° C.) for about one minute to about one and a half minutes at each area of the tubing 46. In one example, each area of the tubing 46 is about one square inch. The shrinkage and reduction in size of the shrinkable cover 64 secures the layers of the tubing 46 together and provides a tight seal around the insulation layer 50 and at ends 68 of the tubing 46.

Returning to FIG. 2, the tubing 46 has an outer diameter of about 0.5 inch (1.3 cm) to about 2.0 inch (5.1 cm). The inner tube 48 provides a conduit that allows the fluid to flow through the fluid system 44. The insulation layer 50 is located outside the inner tube 48 to thermally insulate the inner tube 48. The tape layer 62 is located outside the insulation layer 50 to secure the insulation layer 50 over the inner tube 48. Finally, a shrinkable cover 64 is located outside the tape layer 62 to provide a seal over the tape layer 62 once the shrinkable cover 64 shrinks upon exposure to heat.

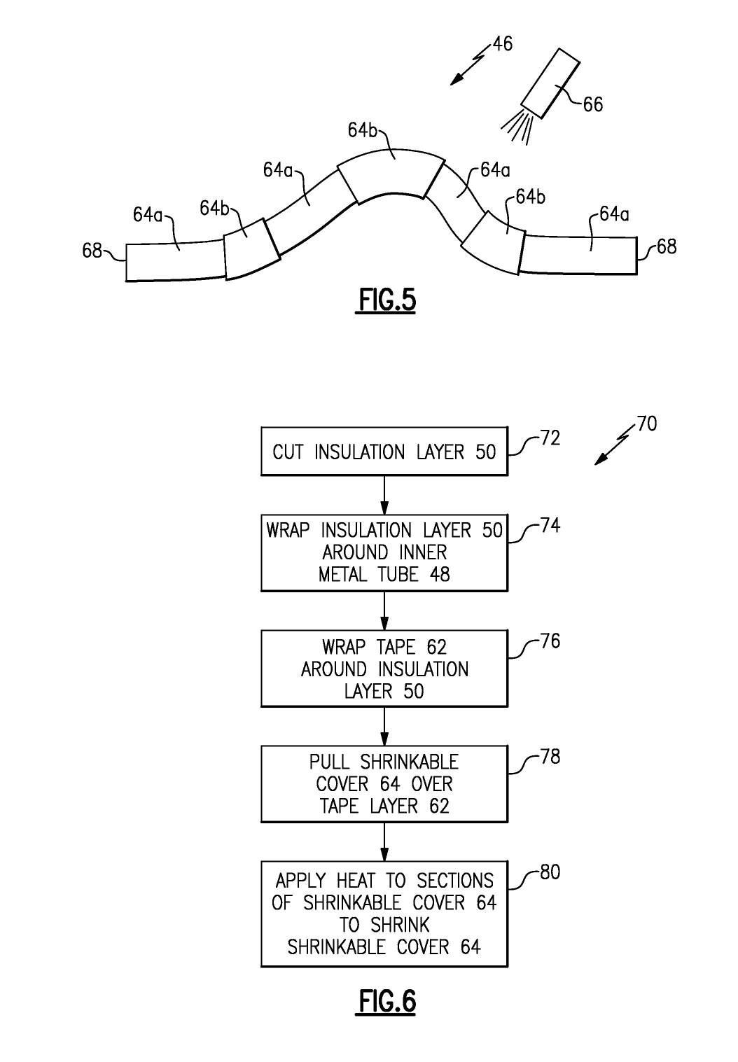

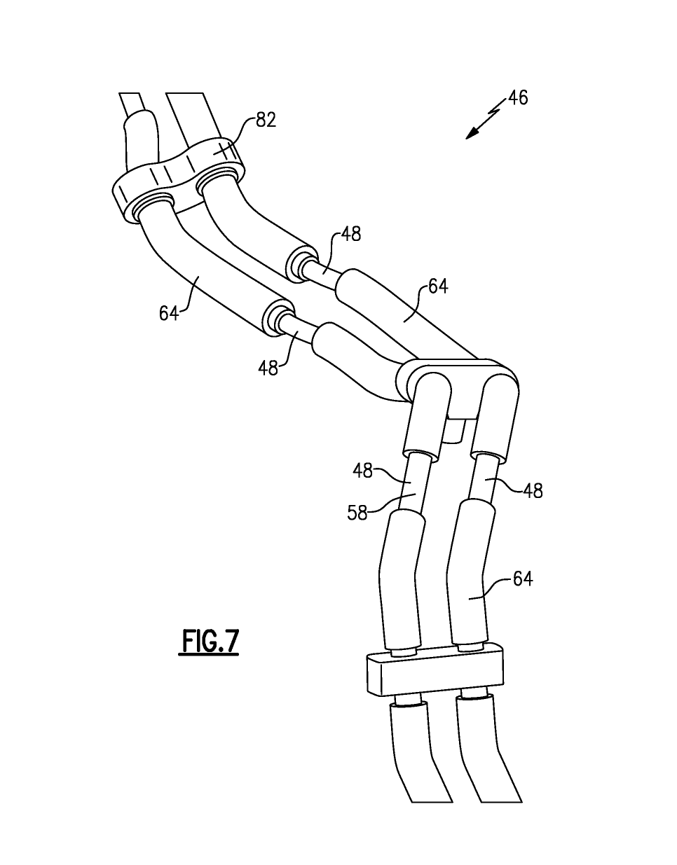

FIG. 6 illustrates a method 70 of forming the tubing 46. As explained above, in step 72, the insulation layer 50 is cut to a desired shape. In step 74, the insulation layer 50 is then wrapped around the outer surface 58 of the inner tube 48. In step 76, the tape is wrapped around the insulation layer 50 to form the tape layer 62 that secures the insulation layer 50 over the inner tube 48. In step 78, the shrinkable cover 64 is then pulled in sections 64a and 64b over the tape layer 62. In step 80, heat is applied to the shrinkable cover 64 to shrink the shrinkable cover 64 and seal the insulation layer 50 and the ends 68 of the tubing 46.

In one example shown in FIG. 7, some sections of the tubing 46 include the insulation layer 50, the tape layer 62, and the shrinkable cover 64, and some sections of the tubing 46 do not include these layers such that the inner tube 48 is exposed. Clamps, instruments, or other devices 82 can be attached to the tubing 46 at the exposed areas of the inner tube 48.

The tubing 46 provides about 0.39 BTU protection to the fluid flowing through the tubing 46 to temperatures up to about 1000° F. (537.7° C.). The tubing 46 also provides for a quick assembly with a reduced cost.

In another example, the insulation layer 50 and the tape layer 62 are wrapped around a component of the gas turbine engine 10 to provide insulation, and the shrinkable cover 64 is located over the tape layer 62 and heated to seal the layers over the component.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A tubing comprising:
an inner tube;
an inner middle insulation layer;
an outer middle securing layer; and
an outer shrinkable cover that shrinks upon exposure to heat.

2. The tubing as recited in claim 1 wherein the inner tube is made of one of a nickel alloy, a titanium alloy, a nickel-chromium alloy, and stainless steel.

3. The tubing as recited in claim 1 wherein the inner tube has an outer diameter of about 0.375 inch to about 0.5 inch.

4. The tubing as recited in claim 1 wherein the inner middle insulation layer includes two outer layers and an insulation filler located therebetween.

5. The tubing as recited in claim 4 wherein the two outer layers include ceramic fibers and the insulation filler has a chalky consistency.

6. The tubing as recited in claim 4 wherein the insulation filler is contained in chambers defined between the two outer layers, and the chambers are defined by stitching.

7. The tubing as recited in claim 1 wherein the inner middle insulation layer has a thickness of about 0.14 inch.

8. The tubing as recited in claim 1 wherein the outer middle securing layer is a ceramic tape layer.

9. The tubing as recited in claim 1 wherein the outer middle securing layer has a thickness of about 0.32 inch.

10. The tubing as recited in claim 1 wherein the outer shrinkable cover is polytetrafluoroethylene.

11. The tubing as recited in claim 1 wherein the outer shrinkable cover has an outer diameter of about 0.68 inch to about 0.775 inch.

12. A tubing comprising:
an inner tube of metal;
an inner middle insulation layer;
an outer middle securing layer formed of a ceramic tape layer; and
an outer shrinkable cover of polytetrafluoroethylene that shrinks upon exposure to heat.

13. The tubing as recited in claim 12, wherein the inner tube is made of one of a nickel alloy, a titanium alloy, a nickel-chromium alloy, and stainless steel.

14. The tubing as recited in claim 12 wherein the inner middle insulation layer includes two outer layers and an insulation filler located therebetween, and the two outer layers include ceramic fibers and the insulation filler has a chalky consistency.

15. A method of making a tubing, the method comprising the steps of:
positioning an inner middle insulation layer around an inner tube;
positioning an outer middle securing layer over the inner middle insulation layer to retain the inner middle insulation layer;
pulling an outer shrinkable cover over the outer middle securing layer; and
then heating areas of the outer shrinkable cover to shrink the outer shrinkable cover.

16. The method as recited in claim 15 wherein the inner tube is made of one of a nickel alloy, a titanium alloy, a nickel-chromium alloy, and stainless steel.

17. The method as recited in claim 15 wherein the step of positioning the inner middle insulation layer around the inner tube includes wrapping the inner middle insulation layer around the inner tube such that edges of the inner middle insulation layer contact or overlap, wherein the inner middle insulation layer includes two outer layers and an insulation filler located therebetween, and the two outer layers includes ceramic fibers and the insulation filler has a chalky consistency.

18. The method as recited in claim 15 wherein the step of positioning the outer middle securing layer over the inner middle insulation layer includes wrapping the outer middle securing layer around the inner middle insulation layer, and the outer middle securing layer is formed of ceramic tape.

19. The method as recited in claim 15 wherein the outer shrinkable cover includes small diameter portions and large diameter portions, and the small diameter portions are located over straight portions of the tubing and the large diameter portions are located over curved portions of the tubing, wherein the outer shrinkable cover is polytetrafluoroethylene.

20. The method as recited in claim 15 wherein the step of then heating the areas of the outer shrinkable cover includes applying heat at a temperature of about 750° F. for about one minute to about one and a half minutes at the areas of the tubing.

21. The method as recited in claim 15 wherein the areas of the outer shrinkable cover are about one square inch.
